(19) United States
(12) Patent Application Publication
(10) Pub. No.: US 2018/0361830 A1
(43) Pub. Date: Dec. 20, 2018

(54) DUAL ELECTRIC DRIVE A/C COMPRESSOR SYSTEM AND METHOD

(71) Applicant: FORD GLOBAL TECHNOLOGIES, LLC, Dearborn, MI (US)

(72) Inventors: Eric de Hesselle, Clarkston, MI (US); Steven Michael Cyr, Lake Orion, MI (US)

(21) Appl. No.: 15/626,645

(22) Filed: Jun. 19, 2017

(51) Int. Cl. B60H 1/32

(52) U.S. Cl. CPC B60H 1/3223; B60H 2001/006; B60H 2001/3292; B60H 1/3205

(57) ABSTRACT

An air conditioning system for a motor vehicle includes a base, a first compressor assembly carried on the base, a second compressor assembly carried on the base and a control module configured to align phases and speeds of the first compressor assembly and the second compressor assembly. A related method of isolating a dual air conditioning compressor assembly system is also provided.

### TECHNICAL FIELD

This document relates generally to the motor vehicle equipment field and, more particularly, to a dual electric drive A/C compressor system as well as to a method of isolating that dual electric drive A/C compressor system on a motor vehicle in order to control noise, vibration and harshness (NVH).

### BACKGROUND

Conventional motor vehicles are equipped with belt-driven A/C compressors that are of three piston designs typically mounted to the power train. In contrast, hybrid electric and electric vehicles typically have a high voltage electric motor driven compressor (eA/C) that does not require direct mounting to the power train.

The next generation of electrified motor vehicles will have an increased demand for cooling. When this increased cooling demand is considered in combination with the limited packaging space on the engine block, the eA/C system integration presents an opportunity for the system to be moved off the power train. Moving the eA/C system off the power train provides an opportunity to utilize a dedicated isolation system which reduces the structure-born vibrations and acoustic radiated noise generated by the eA/C.

Due to the additional cooling of the electronics for advanced electrified vehicles, including autonomous vehicles, the thermal energy management systems now require dual eA/C units. Mounting of the dual eA/C units to the body/chassis structure of the motor vehicle faces two new challenges. The first is the loss of engine mass and the second is the loss of the power train mount isolation system which both serve to reduce eA/C system vibrations being transmitted to the motor vehicle occupants.

This document relates to a new and improved eA/C system and related method of isolating dual eA/C compressor assemblies on a motor vehicle.

### SUMMARY

In accordance with the purposes and benefits described herein, a new and improved eA/C system is provided for a motor vehicle. That eA/C system comprises a base, a first compressor assembly carried on that base, a second compressor assembly carried on that base and a control module configured to align phases and speeds of the first compressor assembly and the second compressor assembly so as to reduce NVH.

The first compressor assembly may include a first compressor and a first drive motor. The second compressor assembly may include a second compressor and a second drive motor. The control module may include a first resolver monitoring the first drive motor and a second resolver monitoring the second drive motor. In addition, the control module may include a vibration detection device monitoring the motion or vibration of the base. Further, the control module may include a controller connected to the vibration detection device, the first resolver and the second resolver.

The first resolver and the second resolver may be selected from a group of devices consisting of an analog resolver, a digital resolver, a rotary encoder or combinations thereof.

The eA/C system may further include a dampener securing the base to the motor vehicle. That dampener may be an elastomeric mounting feature to suppress transmission of noise and vibration from the base to the motor vehicle and, more particularly, the body or frame of the motor vehicle.

In accordance with an additional aspect a motor vehicle is provided equipped with the eA/C system described herein.

In accordance with still another aspect, a method is provided of isolating a dual eA/C compressor system on a motor vehicle. That method comprises the steps of mounting a first compressor assembly and a second compressor assembly on a base and reducing vibration by aligning phases and speeds of the first compressor assembly and the second compressor assembly with an isolation system. That isolation system may be dedicated for this purpose.

The method may further include the step of monitoring a first drive motor of the first compressor assembly with a first resolver. Further, the method may include the step of monitoring a second drive motor of the second compressor assembly with a second resolver.

Still further, the method may include the step of monitoring vibration of the base with a vibration monitoring device. Still further the method may include the step of configuring a control module of the isolation system to align phases and the speeds of the first compressor assembly and the second compressor assembly so as to reduce NVH. Toward this end the method may include configuring a controller of the control module to adjust the phases and speeds of the first compressor assembly and the second compressor assembly to cancel noise and vibration in response to data input from the first resolver, the second resolver and the vibration monitoring device.

Still further, the method may include the step of securing the base to the motor vehicle by means of a dampener. That dampener may take a number of forms including, but not necessarily limited to, an elastomeric mount.

In the following description, there are shown and described several preferred embodiments of the eA/C system. As it should be realized, the eA/C and the related method of isolating a dual compressor system of a motor vehicle are capable of other, different embodiments and their several details are capable of modification in various, obvious aspects all without departing from the system and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the eA/C system and related method and together with the description serve to explain certain principles thereof. In the drawing figures:

FIG. 1 is a schematic block diagram of the eA/C system.

FIG. 2a is a schematic illustration of a first embodiment of the eA/C system illustrating the first compressor assembly and the second compressor assembly oriented along two parallel axes on the supporting base.

FIG. 2b is a second possible embodiment of the eA/C system illustrating the first compressor assembly and the second compressor assembly oriented so as to be aligned along a single axis on the supporting base.

FIG. 3 is a schematic high voltage eA/C compressor vibration cancellation logic flow chart.

FIG. 4 is a high voltage eA/C compressor vibration cancellation schematic.

FIG. 5 is a graphic illustration of how the vibration from the first compressor assembly and the vibration from the second compressor assembly are utilized to cancel each other and thereby reduce NVH transmitted by the compressor assemblies through the supporting base to the occupants of the motor vehicle.

Reference will now be made in detail to the present preferred embodiments of the eA/C system and the vibration isolation method, examples of which are illustrated in the accompanying drawing figures.

### DETAILED DESCRIPTION

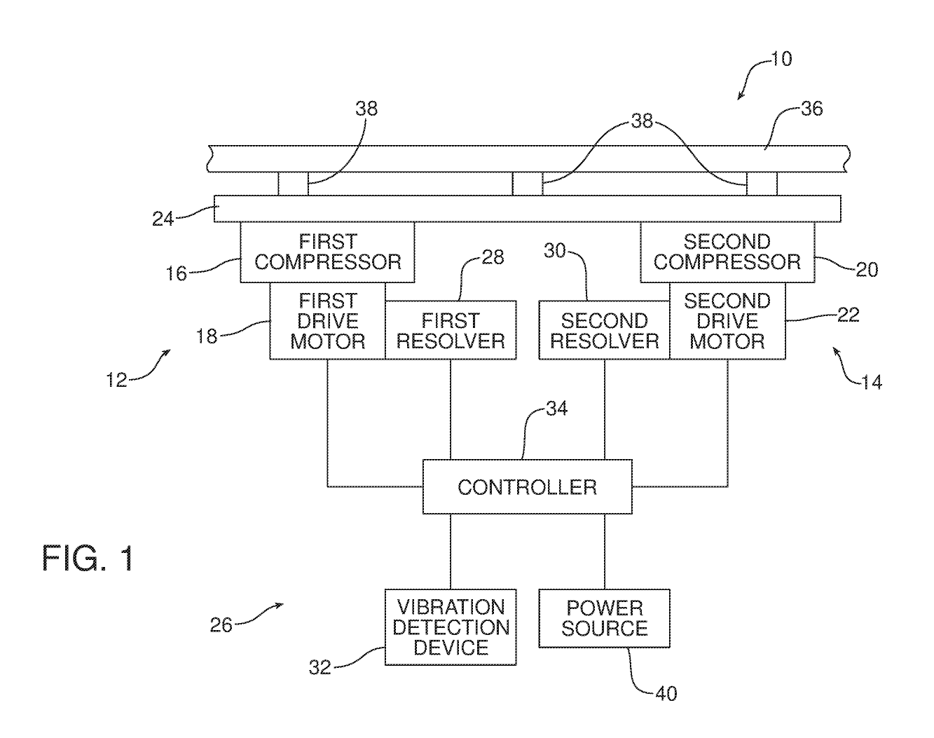

As illustrated in FIG. 1, the eA/C system 10 comprises a dual electric drive A/C compressor system having a first compressor assembly 12 and a second compressor assembly 14. The first compressor assembly 12 includes a first compressor 16 and a cooperating first electric drive motor 18 for driving the first compressor. The second compressor assembly 14 includes a second compressor 20 and a cooperating second electric drive motor 22 for driving the second compressor.

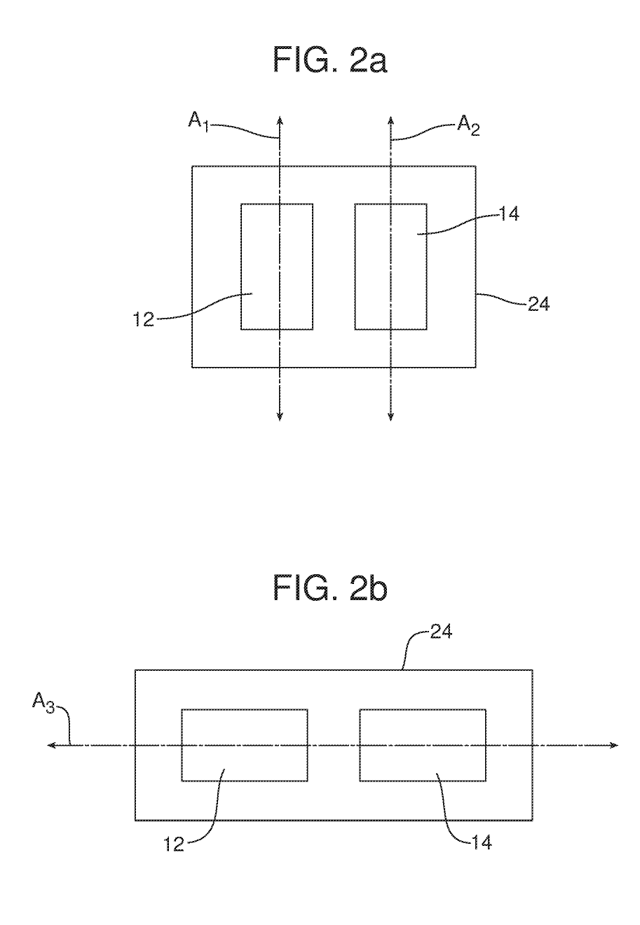

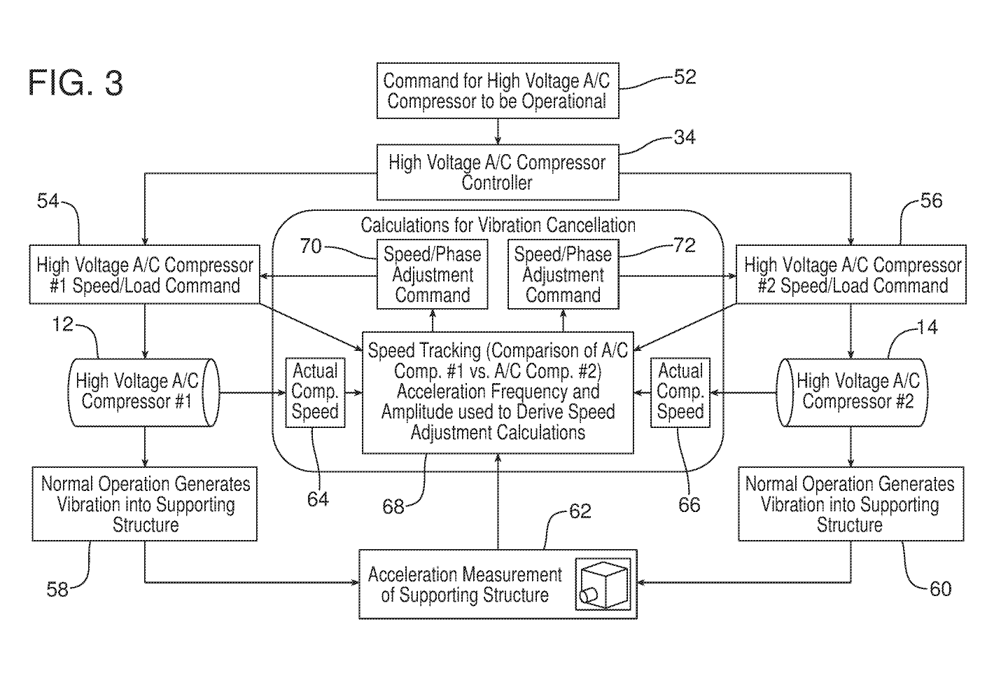

As illustrated in FIGS. 2a and 2b, the first compressor assembly 12 and second compressor assembly 14 are both carried or supported on a bracket or base 24. In the embodiment illustrated in FIG. 2a, the first compressor assembly 12 is oriented along a first axis A₁ while the second compressor assembly 14 is oriented along a second axis A₂ where axis A₁ is parallel to axis A₂. In contrast, as illustrated in FIG. 2b, the first compressor assembly 12 and the second compressor assembly 14 may be oriented on the base 24 so as to be coaxial: that is, aligned along the third axis A₃.

Referring back to FIG. 1, the eA/C system 10 of the illustrated embodiment includes a control module 26 configured to align phases and speeds of the first compressor assembly 12 and the second compressor assembly 14 so as to reduce NVH. More specifically, the control module 26 includes a first resolver 28 that monitors the first drive motor 18 of the first compressor assembly 12 and a second resolver 30 that monitors the second drive motor 22 of the second compressor assembly 14. More specifically, the first resolver 28 and the second resolver 30 function to align the phase and speed of rotation of the first and second driver motors 18, 22. The first resolver 28 may be selected from a group of devices consisting of an analog resolver, a digital resolver or a rotary encoder of a type known in the art and adapted for such a purpose. Similarly, the second resolver 30 may be selected from a group of devices consisting of an analog resolver, a digital resolver, and a rotary encoder of a type known in the art and adapted for such a purpose.

The control module 26 may also include a vibration detection device 32 for monitoring the vibration of the base 24 upon which the first compressor assembly 12 and second compressor assembly 14 are mounted. That vibration detection device 32 may be of a type known in the art suitable for such a use. For example, the vibration detection device 32 may comprise one or more devices for motion detection such as one or more accelerometers.

As further illustrated in FIG. 1, the control module 26 may also include a controller 34. The controller 34 may comprise a computing device such as a dedicated microprocessor or electronic control unit (ECU) operating in accordance with instructions from appropriate control software. Accordingly, the controller 34 may comprise one or more processors, one or more memories and one or more network interfaces all in communication with each other over a communication bus.

The controller 34 may be a dedicated controller exclusively adapted for aligning the phases and speeds of the first and second drive motors 18, 22. Alternatively, the controller 34 may be a multifunctional controller such as a body control module or BCM. As is known in the art, a BCM performs a number of interior body electrically based functions including, for example, interior locking, remote key entry, interior lighting, exterior lighting, windshield wiper control and the like. In some embodiments the BCM may also function to control entertainment functions (e.g. radio, CD player) and communications such as telephone and internet communications over a wireless network. In some embodiments the BCM is connected by a communication bus to other control modules that provide one or more of these additional functions.

As illustrated in FIG. 1, the controller 34 is connected to the vibration detection device 32, the first resolver 28 and the second resolver 30. The controller 34 receives data from the vibration detection device 32 respecting current vibration of the base 24 upon which the first compressor assembly 12 and second compressor assembly 14 are mounted, the first resolver 28 respecting the phase and speed of the first driver motor 18 and the second resolver 30 respecting the phase and speed of the second drive motor 22. In response to this data, the controller 34 adjusts the phase and speed of the first drive motor 18 and the second drive motor 22 to suppress and cancel vibration of the eA/C system in a manner described in greater detail below.

As further illustrated in FIG. 1, the base 24 is mounted or secured to the motor vehicle 36 by means of a dampener 38. In the illustrated embodiment, the dampener 38 comprises three elastomeric mounts that serve to dampen vibration and isolate the base 24, and the first compressor assembly 12 and second compressor assembly 14 fixed thereto, from the occupants of the motor vehicle.

Consistent with the above description, a method is provided of isolating a dual eA/C compressor system 10 on a motor vehicle 36. That method may be broadly described as comprising the steps of mounting the first compressor assembly 12 and the second compressor assembly 14 on the base 24 and reducing vibration by aligning the phases and speeds of the first compressor assembly 12 and the second compressor assembly 14 with the control module 26. Toward this end, the method includes the step of monitoring the first drive motor 18 of the first compressor assembly 12 with the first resolver 28. Further, the method includes the step of monitoring the second drive motor 22 of the second compressor assembly 14 with the second resolver 30. In addition, the method includes monitoring vibration of the base 24 with the vibration monitoring device 32.

Still further, the method includes configuring the control module 26 to align the phases and speeds of the first compressor assembly 12 and the second compressor assembly 14 so as to reduce NVH. This includes configuring the controller 34 to adjust the phases and speeds of the first compressor assembly 12 and the second compressor assembly 14 to cancel noise and vibration in response to data input from the first resolver 28, the second resolver 30 and the vibration monitoring device 32.

In order to further isolate and control vibration, the method also includes securing the base 34 to the motor vehicle 36 by means of a dampener 38 such as the illustrated elastomeric mounts.

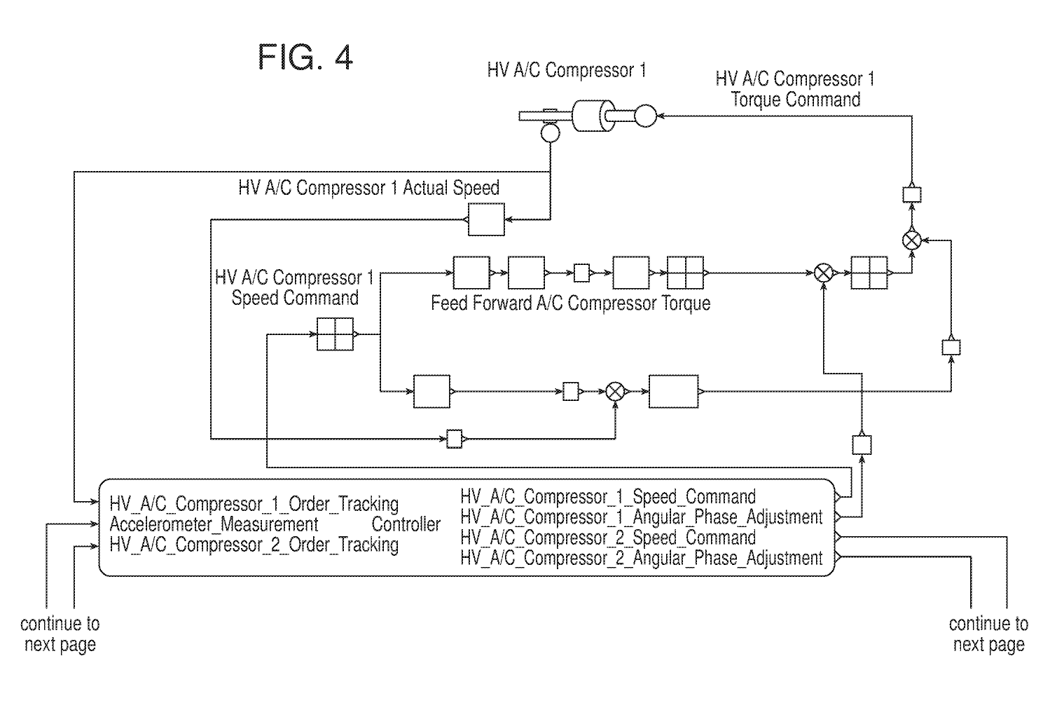

FIG. 3 illustrates one possible vibration cancellation logic flow chart for the eA/C system 10 and the related method of isolating the dual eA/C compressor system 10. When the operating systems of the electrified motor vehicle 36 require cooling, the controller 34 of the control module 26 receives a command for the dual eA/C compressor to be operational as shown in box 52. The controller 34 then sends a speed/load command (note box 54) to the first compressor assembly 12 and a second speed/load command (note box 56) to the second compressor assembly 14. In some embodiments, the controller 34 may actually route power from the power source 40 to the first drive motor 18 and second drive motor 22 of the respective first compressor assembly 12 and second compressor assembly 14 (see FIG. 1). As the first compressor assembly 12 and the second compressor assembly 14 operate, each generates vibration (note respective boxes 58, 60) into the base 24 upon which the first compressor assembly and the second compressor assembly are fixed. The vibration detection device 32 monitors the vibration of the base 24 at box 62 while the first resolver 28 tracks the speed of the first compressor assembly 12 by monitoring acceleration frequency, and amplitude of the first drive motor 18 and the second resolver 30 tracks the speed of the second compressor assembly 14 by monitoring the acceleration frequency and amplitude of the second drive motor 22 (note respective boxes 64 and 66). The data respecting vibration of the base 24 from the vibration detection device 32, the speed tracking of the first compressor assembly 12 from the first resolver 28 and the speed tracking of the second compressor assembly 14 from the second resolver 30 is received by the controller 34 which operates in accordance with a vibration isolation algorithm to derive speed adjustment calculations (note box 68) and produce a speed/phase adjustment command (note box 70) for the first drive motor 18 and the first compressor assembly 12 and a speed/phase adjustment command (note box 72) for the second drive motor 22 of the second compressor assembly 14.

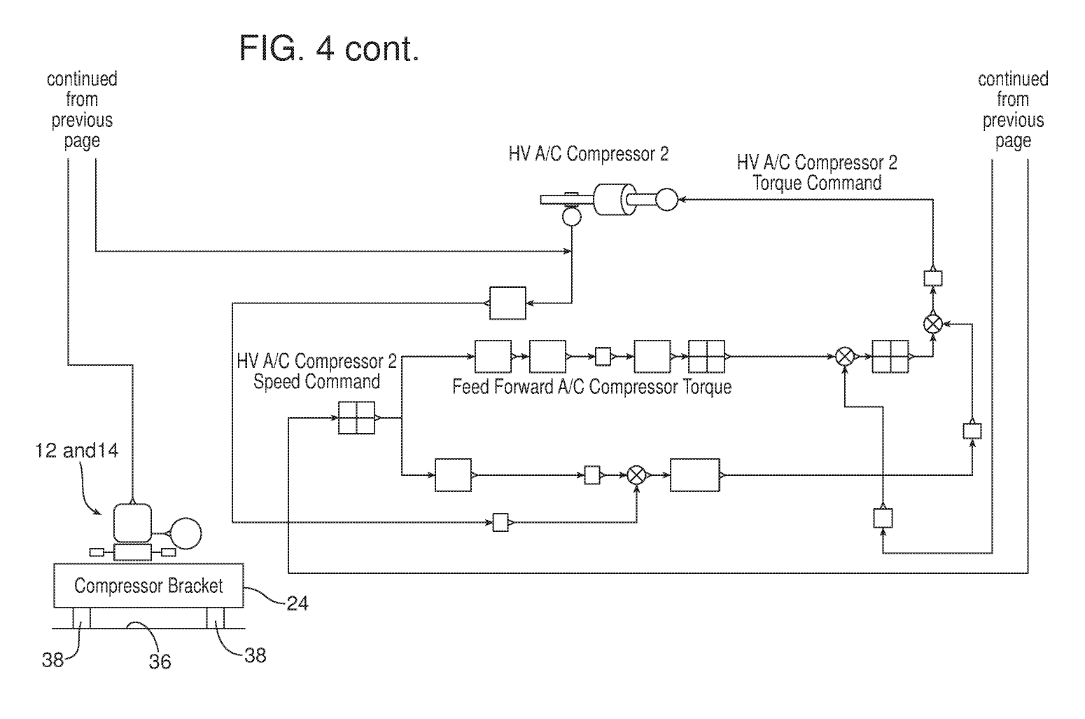

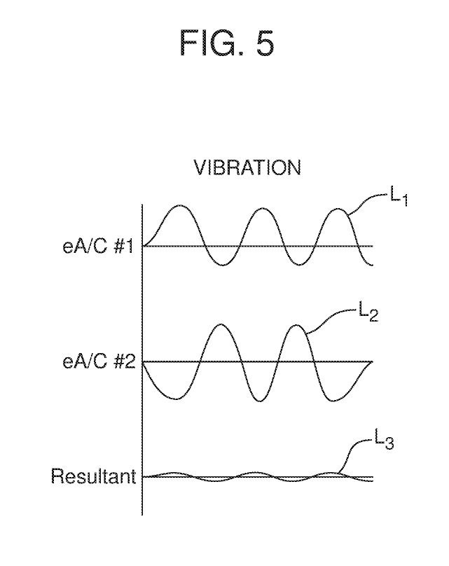

FIG. 4 is a self-explanatory compressor vibration cancellation schematic illustrating this method or process. FIG. 5 graphically illustrates at line L1 the vibration of the first compressor assembly 12, at line L2 the vibration of the second compressor assembly 14 and at line L3 the resulting total vibration generated by operation of the eA/C system 10 (or excitation force into the body structure of the motor vehicle 36) following vibration cancellation by the control module 26. The resulting suppression of the vibration of the eA/C system greatly improves the comfort and satisfaction of the occupants of the motor vehicle.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An eA/C system for a motor vehicle, comprising:
a base;
a first compressor assembly carried on said base;
a second compressor assembly carried on said base; and
a control module configured to align phases and speeds of said first compressor assembly and said second compressor assembly so as to reduce NVH.

2. The eA/C system of claim 1, wherein said first compressor assembly includes a first compressor and a first drive motor and said second compressor assembly includes a second compressor and a second drive motor.

3. The eA/C system of claim 2, wherein said control module includes a first resolver monitoring said first drive motor and a second resolver monitoring said second drive motor.

4. The eA/C system of claim 3, wherein said control module includes a vibration detection device monitoring vibration of said base.

5. The eA/C system of claim 4, wherein said control module includes a controller connected to said vibration detection device, said first resolver and said second resolver.

6. The eA/C system of claim 5, wherein said first resolver and said second resolver are selected from a group of devices consisting of an analog resolver, a digital resolver, a rotary encoder or combinations thereof.

7. The eA/C system of claim 6, further including a dampener securing said base to said motor vehicle.

8. The eA/C system of claim 7, wherein said dampener is an elastomeric mounting feature to suppress transmission of noise and vibration from said base to said motor vehicle.

9. The eA/C system of claim 1, further including a dampener securing said base to said moto vehicle.

10. A motor vehicle equipped with the eA/C system of claim 1.

11. A method of isolating a dual eA/C compressor system on a motor vehicle, comprising:
mounting a first compressor assembly and a second compressor assembly on a base; and
reducing vibration by aligning phases and speeds of said first compressor assembly and said second compressor assembly with a control module.

12. The method of claim 11, including monitoring a first drive motor of said first compressor assembly with a first resolver.

13. The method of claim 12, including monitoring a second drive motor of said second compressor assembly with a second resolver.

14. The method of claim 13, including monitoring vibration of said base with a vibration monitoring device.

15. The method of claim 14, including configuring a control module to align said phases and said speeds of said first compressor assembly and said second compressor assembly so as to reduce NVH.

16. The method of claim 15, including configuring a controller of said control module to adjust said phases and speeds of said first compressor assembly and said second compressor assembly to cancel noise and vibration in response to data input from said first resolver, said second resolver and said vibration monitoring device.

17. The method of claim 16, including securing said base to said motor vehicle by a dampener.

18. The method of claim 11, including securing said base to said motor vehicle by a dampener.

19. The method of claim 11, including configuring said control module to align said phases and said speeds of said first compressor assembly and said second compressor assembly so as to reduce NVH.
